(19) United States
(12) Patent Application Publication
(10) Pub. No.: US 2026/0111241 A1
(43) Pub. Date: Apr. 23, 2026

(54) AUTO SYNCING OF AN APPLICATION POD TO A DESIRED STATE

(71) Applicant: JP Morgan Chase Bank, N.A., New York, NY (US)

(72) Inventors: Udayakumaran SUGUMARAN, Denton, TX (US); Maria MARTINEZ, Denton, TX (US); Vikas KOHLI, Robbinsville, NJ (US)

(73) Assignee: JP Morgan Chase Bank, N.A., New York, NY (US)

(21) Appl. No.: 18/918,983

(22) Filed: Oct. 17, 2024

(51) Int. Cl. G06F 9/445

(52) U.S. Cl. CPC G06F 9/44505

(57) ABSTRACT

There are provided methods and systems for automatically syncing one or more application pods to a desired state. For example, there is provided a system that includes a processor and a memory. The memory includes instructions, which when executed, cause the processor to perform certain operations. The operations may include providing an interface between an observability tool and at least one component of the system. Further, the operations may include verifying an output of the observability tool and verifying a current condition of a state of an application pod. Furthermore, based on a result of verifying the output and a result of verifying the current condition, the operations may further include executing a configuration change in the application pod.

### TECHNICAL FIELD

The present disclosure relates to syncing one or more application pods to a desired state. Particularly, the present disclosure relates to automatically syncing one or more application pods based on one or more outputs of an observability tool.

### BACKGROUND

With the advent of cloud platforms, a plurality of applications may be packaged in a pod. This may be done to service user groups that have common organizational ties or common privileges. For example, and not by limitation, in the Kubernetes framework, an application pod may be the fundamental unit of deployment and management of a set of applications. The application pod may include one or more containers that share the same set of resources. In the example, these resources may be a network, a storage volume, or configuration utilities.

Specifically, each pod may contain one or more containers that work cooperatively as a single application or service. In the cloud system, the containers in the same pod may share the same Internet Protocol (IP) address and the same ports. Furthermore, pods may include common storage volumes shared among containers in the same pod. In sum, state-of-the-art cloud environments contain utilities that may automate the deployment, scaling, and management of containerized applications.

Additional practices may be adopted during such automated deployment, scaling, and management. For example, the continuous integration/continuous deployment (CI/CD) paradigm may be a set of practices that are executed to improve the quality and speed of software development. The CI/CD framework can thus include automated processes for integrating code and deploying software into application pods. Furthermore, machine learning operations (MLOPs) practices and tools may be designed to streamline and optimize development, deployment, and maintenance of applications that utilize machine learning (ML) models.

In the state-of-the-art, applications and their underlying infrastructure are not typically monitored. When such options exist, monitoring tools may show incorrect or missing metrics, and as such, a user may not be aware of actual issues since they may go unnoticed. Furthermore, fixes are manual, thus complicated and lengthy. This increases potential application downtimes.

Generally, there are multiple issues with the state-of-the-art practice of packaging applications into pods. For example, at scale, application pods may experience increased observability errors or may be subjected to prolonged application downtimes. They may also adversely affect system resiliency, self-healing procedures may have limited scope, and there may be significant manual effort and engineering time expenditures to ensure adequate performance.

### SUMMARY

The embodiments featured herein help solve or mitigate the above-noted issues as well as other issues known in the art. The embodiments featured herein are configured to promote or enhance pod state self-healing of application pods.

Embodiments of the present disclosure provide an ability to automatically sync one or more application pods to a desired state based on the outputs of an observability tool. This is achieved through a system that integrates observability tools with components such as MLOPs tools, CI/CD pipeline tools, and Kubernetes-hosted applications. For example, they can automatically execute configuration changes in application pods based on real-time verification of observability tool outputs and the current condition of the pods. This reduces manual intervention and enhances system resiliency.

More specifically, the embodiments may allow improved pod state self-healing in Kubernetes-hosted applications. Furthermore, the embodiments may provide a plurality of advantages over the methods and systems of the state-of-the-art. For example, the embodiments are configured to help reduce observability errors, avoid application downtime, reduce manual effort and engineering time, improve system resiliency, and extend the self-healing scope of Kubernetes-hosted applications.

The embodiments also provide an interface between observability tools and system components, allowing for continuous monitoring and validation of application pod states. This integration helps in reducing observability errors and avoiding application downtime. Systems, according to the embodiments, use AI/machine learning routines to analyze the collected information from the application pods, providing a resilience score and recommendations for fault-tolerant solutions. This adds an intelligent layer to the chaos testing and self-healing process.

A system, according to the embodiments, is designed to work within CI/CD frameworks, ensuring that chaos testing and self-healing processes are consistently and repeatedly applied across all applications during the development lifecycle. This integration helps in maintaining the desired state of application pods throughout their lifecycle.

An exemplary embodiment includes a feedback loop involving MLOPs/AI systems, deployment tools, and job scheduling modules to dynamically fix errors as they arise. This real-time feedback mechanism ensures that the application pods are continually monitored and adjusted to maintain their desired state.

These features collectively provide a robust solution for enhancing the reliability, resiliency, and efficiency of application pods in cloud environments, particularly in Kubernetes-hosted applications.

One exemplary embodiment provides a system that includes a processor and a memory. The memory includes instructions that, when executed, cause the processor to perform certain operations. The operations may include providing an interface between an observability tool and at least one component of the system. Further, the operations may include verifying the output of the observability tool and verifying the current condition of the state of an application pod. Furthermore, based on a result of verifying the output and a result of verifying the current condition, the operations may further include executing a configuration change in the application pod.

The system of any preceding clause, wherein the at least one component is selected from the group of components consisting of a MLOPs tool, a CI/CD pipeline tool, and Kubernetes.

The system of any preceding clause, wherein the at least one component is a CI/CD pipeline tool, and the operations further include utilizing the output of the observability tool as an automatic trigger to self-heal the application pod.

The system of any preceding clause, wherein the operations further include utilizing the observability tool to validate the application pod.

The system of any preceding clause, wherein the operations further include validating the application pod by comparing the current condition with a reference condition.

The system of any preceding clause, wherein the output of the observability tool is an alert of the observability tool and an input to the MLOPs/AI.

The system of any preceding clause, wherein the processor is further configured with logic for verifying an alert from the observability tool.

The system of any preceding clause, wherein the processor is further configured with logic for fixing an error in the application pod.

The system of any preceding clause, wherein the processor is further configured to execute the operations continually.

The system of any preceding clause, wherein the processor is further configured to automate self-healing of the application pod.

Another exemplary embodiment provides a method that resides as instructions on a non-transitory computer-readable medium. The instructions are configured to cause a processor of a system to perform certain operations. The operations may include providing an interface between an observability tool and at least one component of the system. Further, the operations may include verifying the output of the observability tool and verifying the current condition of the state of an application pod. Furthermore, based on a result of verifying the output and a result of verifying the current condition, the operations may further include executing a configuration change in the application pod.

The method of any preceding clause, wherein the operations further include utilizing the observability tool to validate the application pod.

The method of any preceding clause, wherein the operations further include validating the application pod by comparing the current condition with a reference condition.

The method of any preceding clause, wherein the output of the observability tool is an alert of the observability tool and an input to the MLOPs/AI.

The method of any preceding clause, wherein the operations further include verifying the alert.

Yet another exemplary embodiment provides a non-transitory computer-readable medium including instructions configured to cause a processor of a system to perform certain operations. The operations may include providing an interface between an observability tool and at least one component of the system. Further, the operations may include verifying the output of the observability tool and verifying the current condition of the state of an application pod. Furthermore, based on a result of verifying the output and a result of verifying the current condition, the operations may further include executing a configuration change in the application pod.

The non-transitory computer-readable medium of any preceding clause, wherein the operations further include utilizing the observability tool to validate the application pod.

The non-transitory computer-readable medium of any preceding clause, wherein the operations further include validating the application pod by comparing the current condition with a reference condition.

The non-transitory computer-readable medium of any preceding clause, wherein the output of the observability tool is an alert of the observability tool and an input to the MLOPs/AI.

The non-transitory computer-readable medium of any preceding clause, wherein the operations further include verifying the alert.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a system for monitoring the state of an application pod.

FIG. 2 illustrates a system for automated self-healing of an application pod.

FIG. 3 illustrates a method for automated self-healing of an application pod.

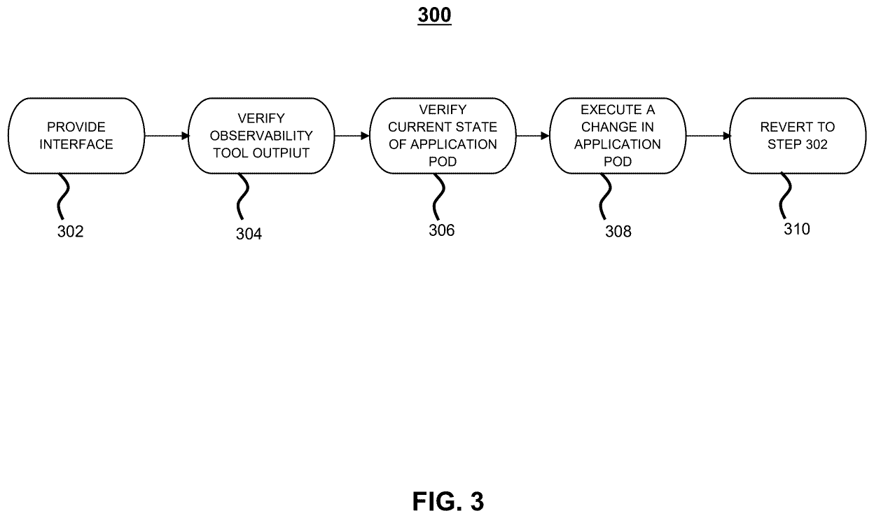

FIG. 4 illustrates a computing system for automated self-healing of an application pod.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

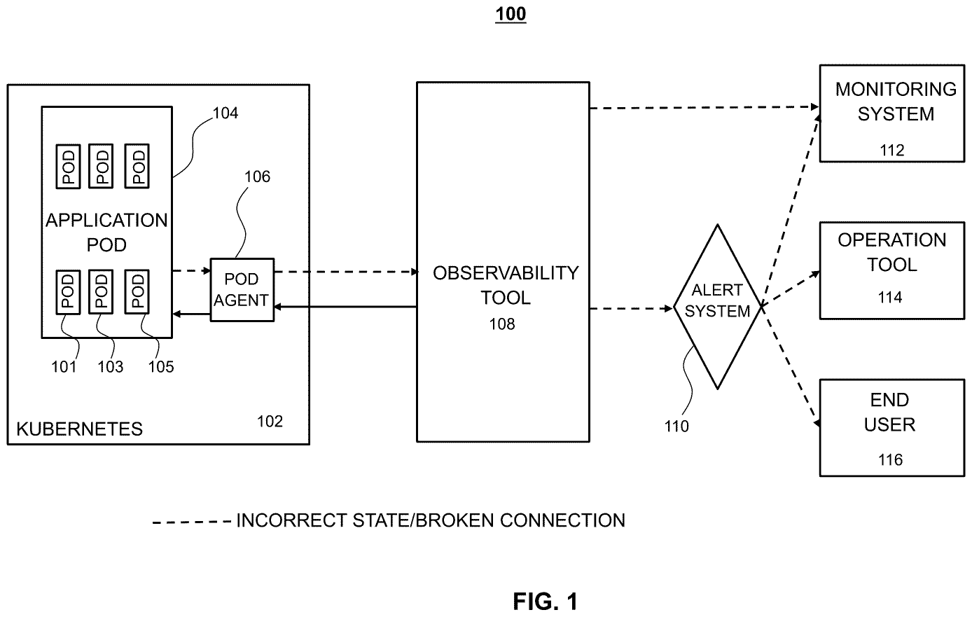

FIG. 1 illustrates a system 100 for monitoring the state of an application pod 104. The application pod 104 may include a plurality of pods (101, 103, and 105), each of which may have a unique state. The application pod 104 may be hosted in a cloud environment. For example, and not by limitation, the environment may be a Kubernetes environment 102.

The Kubernetes environment 102 may be interfaced with an observability tool 108 that is configured to receive information associated with the state of each pod in the application pod 104. Receiving the information may be achieved via a dedicated pod agent 106, and the information may be a data structure including information about the state of each pod. Such information may be time-indexed, and it may be continually or periodically queried by the observability tool 108 via the dedicated pod agent 106 (as indicated by the solid arrow).

Due to the scale and complexity of the application pod 104, upon the observability tool 108 querying the application pod 104 for status, an incorrect or broken connection state may be experienced by the observability tool 108. By way of example, the dashed arrow between the dedicated pod agent 106 and the observability tool 108 represents the broken connection state.

When a broken connection state happens, the observability tool 108 output that is propagated to the alert system/tool 110 does not reflect the correct state of the application pod 104. As a result, downstream systems, such as the monitoring system 112 and the operation tool 114, also receive incorrect information about the application pod 104. Generally, these downstream systems do not receive information about the application pod 104. An end user 116 may also receive the same incorrect information and adversely experience the broken connections experienced by the observability tool 108.

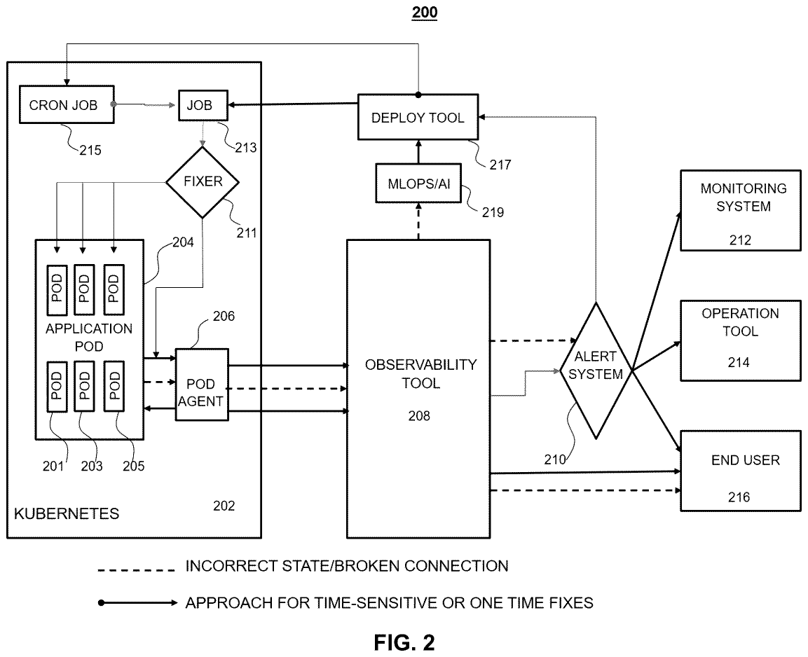

FIG. 2 illustrates a system 200 according to an exemplary embodiment. The system 200 is configured for monitoring the state of an application pod 204 and actively fix errors in the application pod 204 as they arise. Similar to the application pod 104 in FIG. 1, the application pod 204 may include a plurality of pods (201, 203, and 205), each of which may have a state. Further, the system 200 includes an observability tool 208 that interfaces with the application pod 204 located in a cloud environment. For example, and not by limitation, the cloud environment may be a Kubernetes environment 202. The outputs of the observability tool 208 are fed to an MLOPs/AI tool 219, which can output a configuration change to a deployment tool 217. The output of the observability tool 208 can also send an alert with an action to the deployment tool 217.

The deployment tool 217, via the configuration change, can instruct a CRON job module (e.g., a time-based job scheduler) 215 or a JOB module 213 of the Kubernetes environment 202 to effect a change to the application pod 204 based on the errors received by the observability tool 208. The change is effected on the application pod 204 by a fixer module 211. The fixer module 211 may then report the result of the operation to a dedicated pod agent 206, which interfaces with the observability tool 208.

The MLOPs/AI tool 219, the deployment tool 217, and the modules 213 and 215 cooperatively function as a feedback loop that can fix issues as they arise. This approach has several advantages. For example, and not by limitation, this approach helps reduce observability errors, avoid application downtime, reduce manual effort and engineering time, improve system resiliency, and extend the self-healing scope of Kubernetes-hosted applications.

In the system 200, downstream systems such as the monitoring system 212 and the operation tool 214 also receive correct information, via an alert tool 210, about the application pod 204, or generally, they are more likely to receive correct information about the application pod 204, relative to the system 100. Moreover, with the system 200, an end user 216 may receive the correct information via the alert tool 210 more often than they would when the system 100 is used. The system 200 is configured to continually or periodically monitor the application pod 204 and effect changes as errors arise. In this manner, the system 200 is configured to auto-sync the application pod 204 to a desired state.

Another exemplary embodiment includes a method 300, which may reside on a non-transitory-medium of a system configured to perform auto-syncing of an application pod, like the system 200. The method 300 can cause a processor of the system to perform operations consistent with auto-syncing of an application pod. For example, the operations may include providing an interface between an observability tool and at least one component of the system (step 302).

Further, the operations may include verifying an output of the observability tool in step 304 and verifying the current condition of the state of an application pod in step 306. Based on the results of verifying the output and verifying the current condition, the operations may further include executing a configuration change in the application pod in step 308.

The method 300 may end at step 308, or it may revert to step 302 at step 310. Generally, the method 300 may be executed periodically or continually without departing from the teachings of the present disclosure. Furthermore, in the system in which the method 300 is executed, the components of the system may be an MLOPs tool, a CI/CD pipeline tool, or a Kubernetes application tool. The observability tool may be interfaced or integrated with all of the tools, one of the tools, or with a sub-combination thereof.

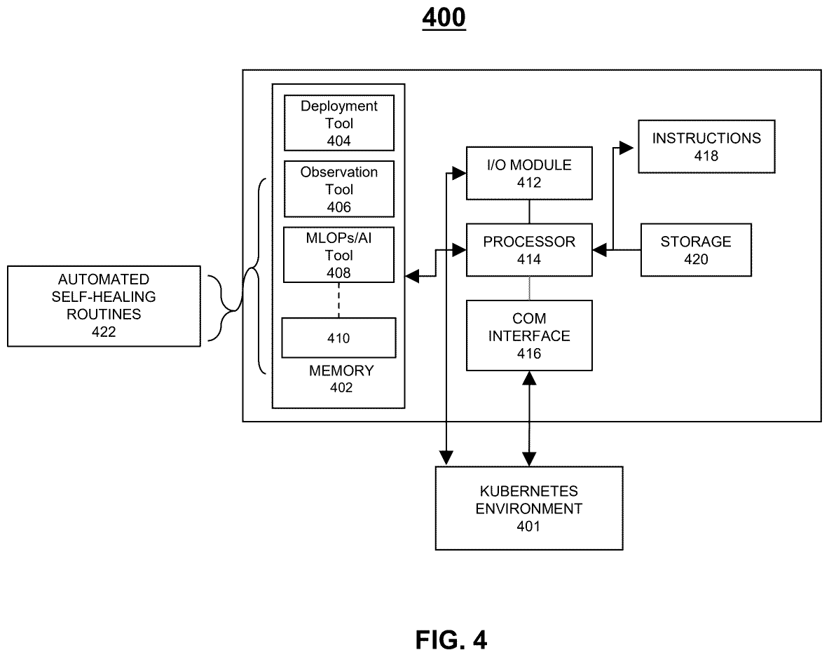

FIG. 4 describes an exemplary computing system 400 configurable to execute the various methods and processes described above. In the computing system 400, a method (e.g., the method 300) or steps thereof as described herein may be embodied as instructions that can cause the computing system 400 to perform operations consistent with auto-syncing an application pod to a desired state using a feedback mechanism to monitor observability errors and dynamically fix, redeploy, or change a state of one or more pods in an application pod. For example, the method may be embodied as instructions residing in a non-transitory component such as a memory or a storage device associated with the computing system 400. That is, the structure of the computing system 400 is imparted by the methods described herein in the form of instructions.

The computing system 400 may be an application-specific hardware, software, and firmware implementation (or a combination thereof) configured to execute the exemplary methods described herein. The system 400 may also represent a structural and application-specific implementation of the other exemplary systems described herein (e.g., the system 200). The computing system 400 can include a processor 414 configured to execute one or more, or all of the blocks of the exemplary methods described previously.

The processor 414 can have a specific structure imparted thereto by instructions 418 stored in a memory 402 and/or by instructions 418 fetchable by the processor 414 from a storage medium 420. The storage medium 420 may be co-located with the computing system 400 as shown, or it can be remote and communicatively coupled to the computing system 400. Such communications may be encrypted.

The computing system 400 may be a stand-alone programmable system, or a programmable module included in a larger system. For example, the computing system 400 can be included as part of a cloud environment or as a part of computing system 400 configured to monitor and reconfigure a cloud environment. Also, the computing system 400 may include one or more hardware and/or software components configured to fetch, decode, execute, store, analyze, distribute, evaluate, and/or categorize information.

The processor 414 may include one or more processing devices or cores (not shown). In some embodiments, the processor 414 may be a plurality of processors, each having one or more cores. The processor 414 can execute instructions fetched from memory 402, i.e., from one of memory modules 404, 406, 408, or 410. By way of example only, and not limitation, the memory module 404 may store instructions that represent the deployment tool 217, the memory module 406 may store instructions that represent the observability tool 208, and the memory module 408 may store instructions that represent the MLOPS/AI tool 219.

Alternatively, the instructions can be fetched from the storage medium 420 or from a remote device connected to the computing system 400 via a communication interface 416. An input/output (I/O) module 412 may be configured for additional communications to or from remote systems or to a user interface 403 from which the processor 414 may receive a set of requirements. Such additional communications may be facilitated by a communications interface 416.

Without loss of generality, the storage medium 420 and/or the memory 402 can include a volatile or non-volatile, magnetic, semiconductor, tape, optical, removable, non-removable, read-only, random-access, or any type of non-transitory computer-readable computer medium. The storage medium 420 and/or the memory 402 may include programs and/or other information usable by processor 414, such as, for example, instructions that enable the processor 414 to perform auto-syncing operations for an application pod in a cloud environment. Furthermore, the storage medium 420 can be configured to log data processed, recorded, or collected during the operation of the system 400.

The data may be time-stamped, location-stamped, cataloged, indexed, encrypted, and/or organized in a variety of ways consistent with data storage practice. By way of example, the memory modules 404 to 410 can form instructions that embody the method 300. In other words, the memory modules 404 to 410 may form a set of automated self-healing routines 422 that can cause the processor 414 to perform certain operations upon execution to auto-sync an application pod of a Kubernetes environment 401 that is communicatively coupled to the system 400.

For example, the operations can include providing an interface between an observability tool and at least one component of the system. Further, the operations may include verifying an output of the observability tool and verifying the current state of an application pod. Furthermore, based on a result of verifying the output and a result of verifying the current condition, the operations may further include executing a configuration change in the application pod.

Having described detailed exemplary embodiments, general embodiments with the structure, features, and advantages provided by the detailed exemplary embodiments are now described. For example, one general embodiment provides a system that includes a processor and a memory. The memory includes instructions, which when executed, cause the processor to perform certain operations. The operations may include providing an interface between an observability tool and at least one component of the system. Further, the operations may include verifying an output of the observability tool and verifying a current condition of a state of an application pod. Furthermore, based on a result of verifying the output and a result of verifying the current condition, the operations may further include executing a configuration change in the application pod.

The system components interfaced with the observability may be an MLOPs tool, a CI/CD pipeline tool, or Kubernetes. The observability tool may be interfaced or integrated with all of them, one of them, or with a sub-combination thereof. When the observability tool is interfaced with the CI/CD pipeline tool, the operations may further include utilizing the output of the observability tool as an automatic trigger to self-heal the application pod.

The operations can further include utilizing the observability tool to validate the application pod, validating the application pod may include comparing the current condition of the application pod with a reference condition. Further, the output of the observability tool is an alert of the observability tool. Furthermore, the processor may be further configured with logic for verifying an alert from the observability tool. The processor may be further configured with logic for fixing an error in the application pod. The processor may be further configured to execute the operations continually. The processor may be further configured to automate self-healing of the application pod.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories.

Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments that may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein.

Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure.

Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative and not restrictive, and the appended claims are intended to cover all such modifications, enhancements, and other embodiments that fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

While the foregoing is directed to embodiments of the present disclosure, other and further embodiments of the disclosure may be devised without departing from the basic scope thereof, and the scope thereof is determined by the claims that follow.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A system, comprising:
a processor;
a memory including instructions, which when executed, cause the processor to perform operations including:
providing an interface between an observability tool and at least one component of the system;
verifying an output of the observability tool;
verifying a current condition of a state of an application pod; and
based on a result of verifying the output and a result of verifying the current condition, executing a configuration change in the application pod.

2. The system of claim 1, wherein the at least one component is selected from the group of components consisting of a Machine Learning Operations (MLOPs) tool, a continuous integration/continuous deployment (CI/CD) pipeline tool, and Kubernetes.

3. The system of claim 1, wherein the at least one component is a continuous integration/continuous deployment (CI/CD) pipeline tool and the operations further include utilizing the output of the observability tool as an automatic trigger to self-heal the application pod.

4. The system of claim 1, wherein the operations further include utilizing the observability tool to validate the application pod.

5. The system of claim 4, wherein the operations further include validating the application pod by comparing the current condition with a reference condition.

6. The system of claim 1, wherein the output of the observability tool is an alert of the observability tool and an input to the MLOPs tool.

7. The system of claim 1, wherein the processor is further configured with logic for verifying an alert from the observability tool.

8. The system of claim 1, wherein the processor is further configured with logic for fixing an error in the application pod.

9. The system of claim 1, wherein the processor is further configured to execute the operations continually.

10. The system of claim 1, wherein the processor is further configured to automate self-healing of the application pod.

11. A method, residing as instructions on a non-transitory computer-readable medium, the instructions configured to cause a processor of a system to perform operations comprising:
providing an interface between an observability tool and at least one component of the system, the at least one component being selected from the group of components consisting of a Machine Learning Operations (MLOPs) tool, a continuous integration/continuous deployment (CI/CD) pipeline tool, and Kubernetes;
verifying an output of the observability tool;
verifying a current condition of a state of an application pod; and
based on a result of verifying the output and a result of verifying the current condition, executing a configuration change in the application pod.

12. The method of claim 11, wherein the operations further include utilizing the observability tool to validate the application pod.

13. The method of claim 12, wherein the operations further include validating the application pod by comparing the current condition with a reference condition.

14. The method of claim 11, wherein the output of the observability tool is an alert of the observability tool and an input to the MLOPs tool.

15. The method of claim 14, wherein the operations further include verifying the alert.

16. A non-transitory computer-readable medium including instructions configured to cause a processor of a system to perform operations comprising:
providing an interface between an observability tool and at least one component of the system, the at least one component being selected from the group of components consisting of a Machine Learning Operations (MLOPs) tool, a continuous integration/continuous deployment (CI/CD) pipeline tool, and Kubernetes;
verifying an output of the observability tool;
verifying a current condition of a state of an application pod; and
based on a result of verifying the output and a result of verifying the current condition, executing a configuration change in the application pod.

17. The non-transitory computer-readable medium of claim 16, wherein the operations further include utilizing the observability tool to validate the application pod.

18. The non-transitory computer-readable medium of claim 17, wherein the operations further include validating the application pod by comparing the current condition with a reference condition.

19. The non-transitory computer-readable medium of claim 16, wherein the output of the observability tool is an alert of the observability tool and an input to the MLOPs tool.

20. The non-transitory computer-readable medium of claim 19, wherein the operations further include verifying the alert.
